(19) United States
(12) Patent Application Publication
(10) Pub. No.: US 2006/0114405 A1
(43) Pub. Date: Jun. 1, 2006

(54) Vertical alignment active matrix liquid crystal display device

(75) Inventors: Minoru Yamaguchi, Tokyo (JP); Ryota Mizusako, Sagamihara-shi (JP); Toshiharu Nishino, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 11/288,522

(22) Filed: Nov. 29, 2005

(30) Foreign Application Priority Data
Nov. 29, 2004 (JP) 2004-343927
Dec. 24, 2004 (JP) 2004-374606

(51) Int. Cl. C09K 19/02; G02F 1/1337

(52) U.S. Cl. 349/178; 349/130

(57) ABSTRACT

A vertical-alignment liquid crystal display device is constituted by a first substrate on which a first electrode is formed, a second substrate on which a second electrode opposed to the first electrode is formed and which is opposed to the first substrate, alignment films respectively on mutually opposing inner surfaces of the first and second substrates, and a liquid crystal layer sealed between the first and second substrates and having negative dielectric anisotropy. On the second electrode, dielectric films having a dielectric constant different from another dielectric constant of the liquid crystal layer in the layer thickness direction of the liquid crystal layer when a voltage is applied between the first and second electrodes are provided at positions respectively corresponding to the center portions of plural pixels.

### BACKGROUND OF THE INVENTION

1. Field of the Invention

The present invention relates to a vertical alignment liquid crystal display device in which liquid crystal sealed between a pair of opposing substrates is vertically aligned in an initial alignment state.

2. Description of the Related Art

A vertical-alignment liquid crystal display device has: a pair of substrates which are opposed to each other with a predetermned gap maintained between each other, plural electrodes which are provided on each of opposed inner surfaces of the paired substrates, to form plural pixels which are constituted by regions opposed to each other and are arrayed in a matrix; vertical-alignment films provided respectively on the inner surfaces of the paired substrates, covering the electrodes; and a liquid crystal layer which is sealed in the gap between the paired substrates and has negative dielectric anisotropy.

In this vertical-alignment liquid crystal display device, the alignment state of liquid crystal is changed from a vertical-alignment state to a tilted-alignment state in which liquid crystal molecules are tilted, by applying a voltage between the electrodes, for every one of the plural pixels consisting of regions where plural pixel electrodes and an opposing electrode are opposed to each other.

In this kind of vertical-alignment liquid crystal display device, there are variants between the tilted-alignment state of respective pixels in which liquid crystal molecules are oriented in accordance with voltages applied to the pixels. The variants cause display unevenness or irregularity.

Hence, in order to stable the alignment state between respective pixels and to attain a wide view angle characteristic, there has been a proposal to form a plurality of domains where the liquid crystal molecules are oriented along plural directions pixel by pixel. For instance, as described in the specification of Japanese Patent Publication No. 2565639, a liquid crystal display apparatus proposed has an opposing electrode formed with an X-shaped aperture, so that liquid crystal molecules in each pixel are so oriented as to tilt toward the center of the X-shaped aperture along four directions when a voltage is applied between two electrodes opposed each other.

In the liquid crystal display apparatus described above, however, regions having different alignment directions are formed due to the X-shaped aperture formed in each pixel. Therefore, the X-shaped aperture needs to be formed sufficiently wide in order to shut off interactions between the areas each other. Consequently, the aperture in each pixel has a large area which cannot be controlled by electric fields. As a result, the area of the opposing electrode is reduced and lowers the aperture ratio.

### SUMMARY OF THE INVENTION

An object of the present invention is to provide a liquid crystal display device which has bright display and a wide view angle without display unevenness.

To achieve the above object, a liquid crystal display device according to the first aspect of the present invention comprises: a pair of substrates opposed to each other with a predetermined gap maintained therebetween; electrodes provided respectively on mutually opposing inner surfaces of the pair of substrates, and defining plural pixels by mutually opposing regions, the plural pixels being arrayed in a matrix; dielectric films provided respectively corresponding to substantial center portions of regions of one of the substrates, the regions corresponding to the plural pixels; vertical-alignment films provided respectively on the inner surfaces of the paired substrates, covering the electrodes and the dielectric films; and a liquid crystal layer having negative dielectric anisotropy and sealed in the gap between the pair of substrates.

According to the liquid crystal display device of the first aspect as described above, liquid crystal molecules in each pixel can be regularly oriented to tilt from the peripheral portions of the pixel toward the center portion of the pixel, as a signal voltage is applied. As a result, an excellent image without unevenness can be displayed.

Preferably in this liquid crystal display device, the dielectric film is formed at the substantial center of each pixel formed on one of the substrates, and has a dielectric constant different from another dielectric constant of the liquid crystal layer in a layer thickness direction of the liquid crystal layer when a voltage is applied between electrodes of the pair of substrates. Desirably in this case, the dielectric films are formed of a dielectric material having a smaller dielectric constant than the another dielectric constant of the liquid crystal layer in the layer thickness direction thereof when the voltage is applied between the electrodes. Also desirably, the dielectric films are formed of a dielectric material having a dielectric constant which is smaller than further another dielectric constant of liquid crystal in a direction vertical to major axes of molecules of the liquid crystal. Further desirably, the dielectric films are formed of a dielectric material having a dielectric constant which is smaller than further another dielectric constant of liquid crystal in a direction perpendicular to major axes of molecules of the liquid crystal and is greater than still further another dielectric constant of the liquid crystal in a direction parallel to the major axes of molecules of the liquid crystal.

Also preferably in this liquid crystal display device, auxiliary electrodes formed at least along peripheries of the pixels are provided on a surface of one of the substrates opposed to the other substrate, the surface being provided with the electrode. Further desirably, the auxiliary electrode is set to a lower potential than the electrode formed on the other one of the substrates, and the auxiliary electrodes are provided, partially overlapping peripheral portions of the electrodes formed on the one of the substrates.

Further preferably in this liquid crystal display device, the dielectric films form projecting parts at the substantial centers of the pixels respectively, the projecting parts include the electrodes formed on the dielectric films and a vertical-alignment film formed on the electrodes. Further desirably, a plurality of recess parts provided on the inner surface of the other substrate opposed to the one of the substrates on which the projecting parts are formed, the recess parts corresponding to the plurality of aid projecting parts provided on the inner surface of the one of the substrates.

A liquid crystal display device according to the second aspect of the present invention comprises: a first substrate on which at least one electrode is provided; a second substrate which is opposed to the first substrate with a predetermined gap maintained from the first substrate, and on which at least one second electrode is provided, each of the at least one the second electrode defining a pixel by a region opposed to the first electrode, to array the plural pixels in a matrix; auxiliary electrodes formed at least along peripheries of regions of the pixels, on a surface of the second substrate where the second electrode is provided; dielectric films which are provided respectively corresponding to substantial center portions of pixels of the first substrate and have a dielectric constant different from another dielectric constant of a liquid crystal layer in a layer thickness direction when a voltage is applied between the first and second electrodes; vertical-alignment films provided respectively on mutually opposing inner surfaces of the first and second substrates, covering the first and second electrodes and the dielectric films; and the liquid crystal layer sealed between the first and second substrates and having negative dielectric anisotropy.

According to the liquid crystal display device of the second aspect, the dielectric films are formed of a dielectric material having a dielectric constant different from the dielectric constant of the liquid crystal layer in the layer thickness direction. Therefore, liquid crystal molecules in each pixel can be more regularly oriented to tilt from the peripheral portions of the pixel toward the center portion of the pixel. As a result, a more excellent image without unevenness can be displayed.

Preferably in this liquid crystal display device, the dielectric films are formed on the first electrode provided on the first substrate, and the vertical-alignment film is formed on the dielectric films. Desirably in this case, the dielectric films are formed of a dielectric material having a smaller dielectric constant than another dielectric constant of the liquid crystal layer in a layer thickness direction thereof when a voltage is applied between the electrodes, and the dielectric films are formed of a dielectric material having a dielectric constant which is smaller than another dielectric constant of liquid crystal in a direction vertical to major axes of molecules of the liquid crystal, or the dielectric films are formed of a dielectric material having a dielectric constant which is smaller than another dielectric constant of liquid crystal in a direction vertical to major axes of molecules of the liquid crystal and is greater than still another dielectric constant of the liquid crystal in a direction parallel to the major axes of molecules of the liquid crystal.

Also preferably in this liquid crystal display device, the auxiliary electrodes are formed substantially throughout the whole peripheries of the second electrode. Further desirably, an active element connected to each of the at least one second electrode to supply the second electrode with a voltage is provided on the second substrate, and the auxiliary electrodes each are constituted by a compensating-capacitor electrode which is provided partly overlapping a peripheral portion of the second electrode formed on the second substrate, to form a compensating capacitor between the second electrode and the auxiliary electrode. Desirably in this case, the compensation auxiliary electrode is set to a potential equal to that of the first electrode.

A liquid crystal display device according to the third aspect of the present invention comprises: a first substrate on which at least one electrode is provided; a second substrate which is opposed to the first substrate with a predetermined gap maintained from the first substrate, and on which at least one second electrode is provided, each of the at least one the second electrode forming a pixel by a region opposed to the first electrode, to array the plural pixels in a matrix; auxiliary electrodes formed at least along peripheries of regions of the pixels, on a surface of the second substrate where the second electrode is provided; dielectric films which are formed between the first electrode and the first substrate, respectively corresponding to substantial center portions of regions of the first substrate, the regions corresponding to the plural pixels, thereby to form convex portions on a surface of the first electrode; vertical-alignment films provided respectively on mutually opposing inner surfaces of the first and second substrates, covering the first and second electrodes; and a liquid crystal layer sealed between the first and second substrates and having negative dielectric anisotropy.

According to the liquid crystal display device of the third aspect, the convex parts can define the tilting direction in which liquid crystal molecules is tilted by application of a signal voltage such that the liquid crystal molecules tilt from the peripheral portions of the pixel toward the center portion of the pixel. Therefore, liquid crystal molecules in each pixel can be regularly oriented with more steadiness, so that much more excellent image can be displayed.

Further desirably in the liquid crystal display device, plural concave parts are provided at positions on the second substrate opposed to the first substrate on which the convex parts are formed, the positions respectively corresponding to the plural convex parts.

### BRIEF DESCRIPTION OF THE DRAWINGS

These objects and other objects and advantages of the present invention will become more apparent upon reading of the following detailed description and the accompanying drawings in which:

FIG. 1 is a plan view showing a planar structure of one pixel part in one of substrates in a liquid crystal display device according to the first embodiment of the present invention;

FIG. 2 is a cross-sectional view cut along the line II-II in FIG. 1;

FIG. 3 is a cross-sectional view cut along the line III-III in FIG. 1;

FIG. 4 is a schematic view showing an alignment state of liquid crystal molecules tilted by application of an electric field in the first embodiment, projected on a plan view;

FIG. 5 is a schematic view showing the tilted-alignment state shown in FIG. 4, on a cross-sectional view;

FIG. 6 is an equivalent circuit diagram showing a part where a dielectric film is formed in the liquid crystal display device, drawn as an electric circuit diagram;

FIG. 7 is a potential distribution graph showing changes of potentials in the liquid crystal layer thickness direction;

FIG. 8 is a plan view showing a planar structure of one pixel part of one substrate in a liquid crystal display device according to the second embodiment;

FIG. 9 is a cross-sectional view cut along the line IX-IX in FIG. 8;

FIG. 10 is a cross-sectional view cut along the line X-X in FIG. 8;

FIG. 11 is a schematic view showing an alignment state of liquid crystal molecules tilted by application of an electric field in the second embodiment, on a cross-sectional view;

FIG. 12 is a schematic view showing the tilted-alignment state shown in FIG. 11, projected on a plan view;

FIG. 13 is a cross-sectional view showing a cross-sectional structure of one pixel part of one substrate in a liquid crystal display device according to the third embodiment; and

FIG. 14 is a schematic view showing the tilted-alignment state shown in FIG. 13, on a cross-sectional view

### DETAILED DESCRIPTION OF THE PREFERRED EMBODIMENTS

Liquid crystal display devices will be described below as embodiments of the present invention with reference to the accompanying drawings.

### First Embodiment

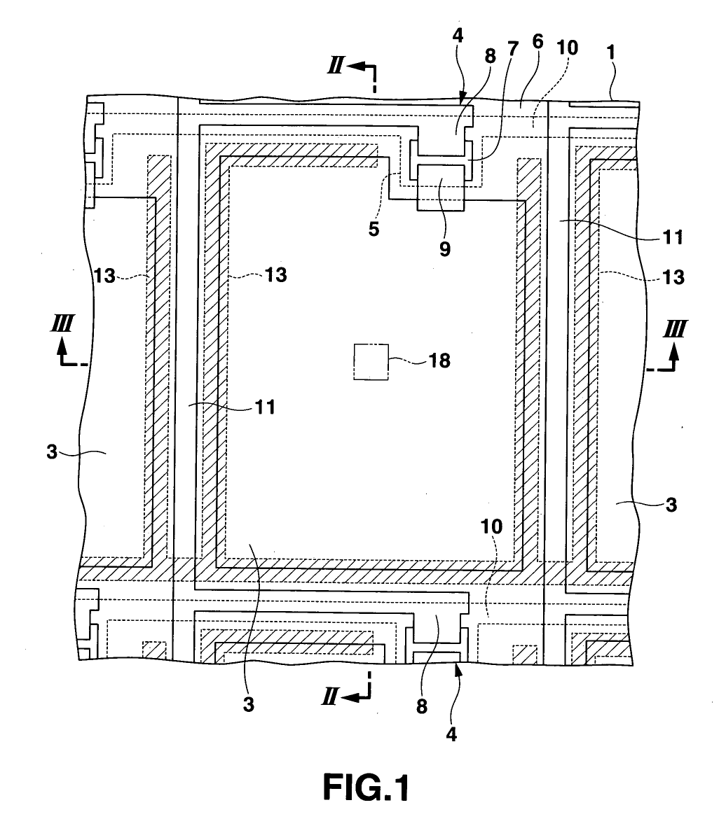

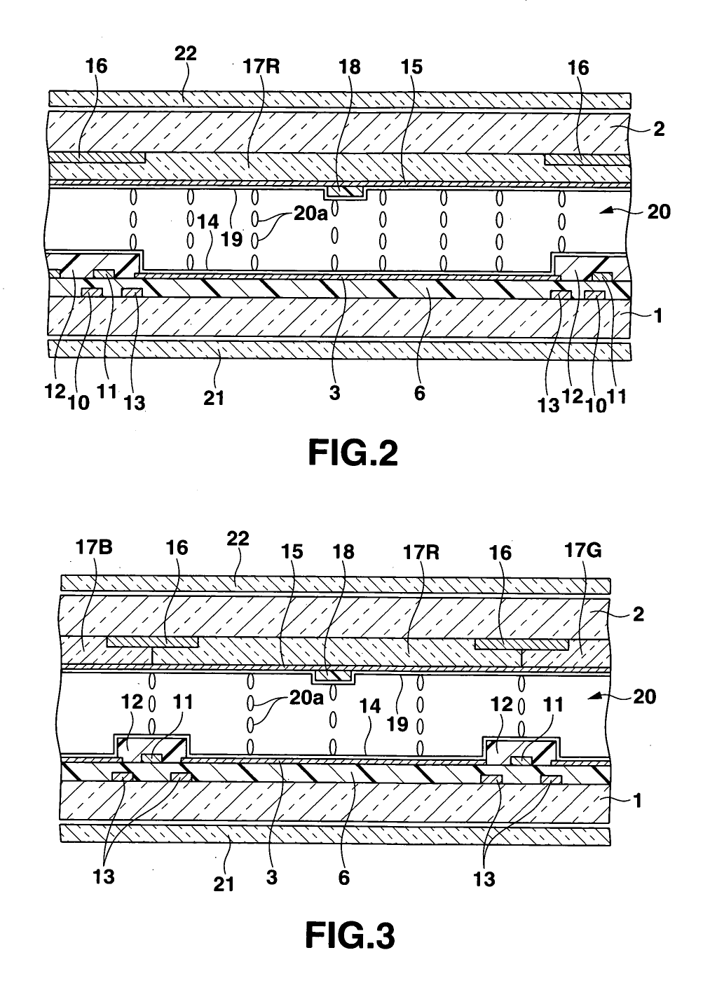

FIGS. 1 to 7 shows an embodiment of the present invention. FIG. 1 is a plan view of one pixel part in one substrate of a liquid crystal display device. FIGS. 2 and 3 are cross-sectional views showing the liquid crystal display device, cut along the lines II-II and III-III in FIG. 1.

As shown in FIGS. 1 to 3, this liquid crystal display device has a pair of transparent substrates 1 and 2 opposed to each other with a predetermined gap maintained therebetween; transparent electrodes 3 and 15 which are provided on mutually opposing inner surfaces of the paired substrates 1 and 2 and form plural pixels arrayed in a matrix by regions opposed to each other, dielectric films 18 provided on the transparent electrode 15 formed on the transparent substrate 2, corresponding to the center portions of the plural pixels; vertical-alignment films 14 and 19 provided on the inner surfaces of the paired substrates 1 and 2, respectively covering the electrodes 3 and 15 and the dielectric films 18; and a liquid crystal layer 20 sealed between the paired substrates 1 and 2 having negative dielectric anisotropy.

This liquid crystal display device is an active matrix liquid crystal display device in which TFTs (Thin Film Transistors) 4 are active elements. The electrodes 3 provided on the inner surface of one substrate 1 are plural pixel electrodes arrayed in a matrix in the row and column directions. The electrode 15 provided on the inner surface of the other substrate 2 is a single-film-type opposing electrode opposed to the plural pixel electrodes 3.

Formed on the inner surface of the former one substrate 1 are plural TFTs 4, plural gate lines 10, and plural data lines 11. The plural TFTs 4 are connected respectively to corresponding pixel electrodes 3. The plural gate lines 10 and data lines 11 are provided respectively along one sides of pixel rows and along also one sides of pixel columns, and respectively supply gate signals and data signals to TFTs 4 in corresponding rows and columns.

Hereinafter, the one substrate on which the pixel electrodes 3, TFTs 4, gate lines 10, and data lines 11 are provided is called a TFT substrate. The other substrate 2 on which the opposing electrode 15 and dielectric films 18 are provided is called an opposing substrate.

The plural TFTs 4 have: gate electrodes 5 formed on the substrate surface of the TFT substrate 1; a transparent gate insulating film 6 formed over the whole of the arrayed region of the pixel electrodes 3, covering the gate electrodes 5; i-type semiconductor films 7 formed on the gate insulating film 6, opposed to the gate electrodes 5; and drain electrodes 8 and source electrodes 9 which are respectively formed on one side parts and other side parts of channel regions of the i-type semiconductor films 7, with an n-type semiconductor film inserted thereunder.

The gate lines 10 are formed on the substrate surface of the TFT substrate 1, integrally with the gate electrodes 5 of the TFTs 4. The data lines 11 are formed on the gate insulating film 6, integrally with the drain electrodes 8 of the TFTs 4.

The pixel electrodes 3 are formed on the gate insulating film 6. The source electrodes 9 of the TFTs 4 are extended to above the gate insulting film 6 and are connected to end portions of the pixel electrodes 3.

Further, the TFTs 4 and the data lines 11 are covered with an over coat insulating film 12 formed on the inner surface of the TFT substrate 1, except for parts corresponding to respective pixel electrodes 3. The vertical-alignment film 14 is formed on the film 12.

Further on the inner surface of the TFT substrate 1, auxiliary electrodes 13 are formed on the substrate surface, corresponding to peripheral portions of the plural pixel electrodes 3, between adjacent pixel electrodes 3. The auxiliary electrodes 13 are formed along the peripheral portions of a pixel electrode 3, such that the auxiliary electrodes 13 partially overlap the pixel electrodes 3 with an insulating layer inserted therebetween. The auxiliary electrodes 13 also form compensating capacitor between the auxiliary electrodes 13 and the pixel electrodes 3, with the gate insulating film 6 used as an insulating layer. In this embodiment, the auxiliary electrodes 13 are provided throughout the whole peripheries of the pixel electrodes 3 except those parts of the pixel electrodes 3 that are adjacent to the TFTs 4, and also serve as compensating-capacitor electrodes. In FIG. 1, parts corresponding to the auxiliary electrodes 13 are hatched with parallel oblique lines to help easy understanding of the figure.

In each row of pixel electrodes, the auxiliary electrodes 13 which respectively correspond to peripheral portions of the plural electrodes 3 are connected integrally to each other, on one end side opposite to the side of the gate line 10. Further, the auxiliary electrodes 13 in each row are connected, in common, to an auxiliary electrode connection line not shown but provided in parallel with the data lines 11, on one end or on each of two ends outside the arrayed region of the plural pixel electrodes 3.

Meanwhile, this liquid crystal display device is a color image display device. A lattice-film-like black mask 16, and three color filters 17R, 17G, and 17B of red, green, and blue are provided on the inner surface of the opposing substrate 2. The black mask 16 is opposed to regions between plural pixels consisting of regions where the plural pixel electrodes 3 and the opposing electrode 15 are opposed to each other Each of the color filters 17R, 17G, and 17B corresponds to one pixel column. The opposing electrode 15 is formed on the color filters 17R, 17G, and 17B.

The dielectric films 18 are formed, for example, like rectangular dots, on the opposing electrode 15 at positions corresponding to substantial center portions of the plural pixels. A vertical-alignment film 19 is formed on the dielectric films 18.

The paired substrates 1 and 2 are joined to each other by a frame-like seal material not shown but surrounding the arrayed region of the plural pixel electrodes 3. A liquid crystal layer 20 is sealed in a region surrounded by the seal material between these substrates 1 and 2.

This liquid crystal layer 20 is constituted by nematic liquid crystal having negative dielectric anisotropy. The dielectric film 18 is formed of a dielectric material having a dielectric constant which is different from the dielectric constant of the liquid crystal layer 20 in the thickness direction of the layer when a voltage is applied between the electrodes 3 and 15 of the paired substrates 1 and 2 of the liquid crystal layer 20. In this case, the highest voltage is applied between the electrodes 3 and 15 among voltages corresponding to plural gradation tones to be written into each pixel.

Where the dielectric constant of the liquid crystal layer 20 in the layer-thickness direction is ε_{LC} and the dielectric constant of the dielectric film 18 is ε_{F} when a voltage is applied between the electrodes 3 and 15, these dielectric constants ε_{LC} and ε_{F} satisfy a relationship of ε_{F}<ε_{LC}.

That is, in this liquid crystal display device, the dielectric film 18 is formed of a dielectric material having a smaller dielectric constant ε_{F} than the dielectric constant ε_{LC} of the liquid crystal layer 20 in the layer thickness direction when a voltage is applied between the electrodes 3 and 15.

A dielectric constant ε_{⊥} in the direction vertical to the major axis of molecules of liquid crystal having the negative dielectric anisotropy and a dielectric constant ε_{∥} parallel to the axis of molecules satisfy a relationship of ε_{∥}<ε_{⊥}. Therefore, in this embodiment, the dielectric film 18 is formed of a dielectric material having a dielectric constant smaller than the dielectric constant ε_{⊥} in the direction vertical to the major axis of molecules of the liquid crystal.

Further, in this embodiment, the dielectric film 18 is formed of a dielectric material having a dielectric constant which is smaller than the dielectric constant ε_{⊥} in the direction vertical to the major axis of molecules of the liquid crystal and greater than the dielectric constant in the direction parallel to the major axis of molecules of the liquid crystal.

That is, the dielectric constant ε_{F} of the dielectric film 18 and the dielectric constants ε_{⊥}, and ε_{∥} in the directions vertical and parallel to the axis of molecules of the liquid crystal satisfy a relationship below.
ε_{∥}<ε_{F}ε_{⊥}

Liquid crystal molecules 20a of the liquid crystal layer 20 are aligned in a vertical-alignment state in which the axis of molecules is oriented in the direction substantially vertical to the surfaces of the substrates 1 and 2, by the vertical-alignment characteristic of the vertical-alignment films 14 and 19 provided respectively on the inner surfaces of the paired substrates 1 and 2.

Though not shown in the figures, the TFT substrate 1 has extension portions protruding to the outside of the opposing substrate 2, respectively at ends in the row and column directions of the TFT substrate 1. Plural gate-side driver connection terminals are formed to be arrayed on the extension portion in the row direction. Plural data-side driver connection terminals are formed to be arrayed on the other extension portion in the column direction.

Further, the plural gate lines 10 described previously are guided by the extension portion in the row direction, and are respectively connected to the plural gate-side driver connection terminals. The plural data lines 11 also described previously are guided by the extension portion in the column direction, and are respectively connected to the data-side driver connection terminals. Auxiliary electrode connection lines described previously are guided by one or both of the extension portions in the row and column directions, and are connected to those voltage terminals that are applied with a predetermined potential among the plural driver connection terminals of the extension portions.

Further on the inner surface of the TFT substrate 1, there is provided at least one opposing-electrode connection line which is guided by one or both of the extension portions in the row and column directions from a corner portion of the substrate joining part joined by the seal material described above and is connected to the voltage terminals also described above of the driver connection terminals. The opposing electrode 15 provided on the inner surface of the opposing substrate 2 is connected to the opposing-electrode connection line at the substrate-joining part, and is connected to the voltage terminals through the opposing-electrode connection line.

On the outer surfaces of the paired substrates 1 and 2, respectively, polarizing plates 21 and 22 are arranged, with their transmission axes oriented in predetermined directions. In this embodiment, the polarizing plates 21 and 22 are arranged at substantially right angles to each other, to make the liquid crystal display device perform display in a normally-black mode.

In this liquid crystal display device, a signal voltage as a voltage corresponding to image data to be displayed is applied between the pixel electrode 3 and the opposing electrode 15, for every pixel. Liquid crystal molecules 20a are thereby oriented to tilt from the vertical-alignment state. Thus, an image is displayed.

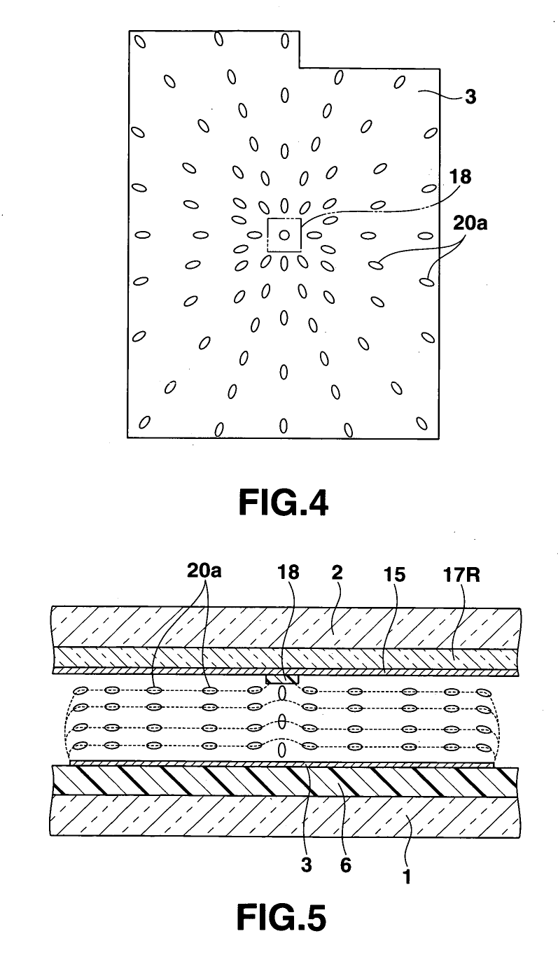

FIGS. 4 and 5 are plan and cross-sectional views showing a tilted-alignment state of liquid crystal molecules 20a in one pixel region of the liquid crystal display device. For every pixel, the liquid crystal molecules 20a are oriented to tilt toward the center portion from the peripheral portions of the pixel as a signal voltage described above is applied.

In this case, in this liquid crystal display device, the dielectric films 18 having the dielectric constant ε_{F} which is different from the dielectric constant ε_{LC} in the layer thickness direction of the liquid crystal layer 20 when a voltage is applied between the electrodes 3 and 15 of the paired substrates 1 and 2 are provided on the opposing electrode 15 of the opposing substrate 2 respectively corresponding to the center portions of the plural pixels. Therefore, the application of a signal voltage between the electrodes 3 and 15 causes the electric field generated in the liquid crystal layer between these electrodes 3 and 15 to weaken in the regions of the center portions of pixels corresponding to the dielectric films 18, compared with other regions which are out of the dielectric films 18. The electric field intensity distribution of the liquid crystal layer is as expressed by equipotential lines shown as broken lines in FIG. 5. The major axes of liquid crystal molecules are aligned in parallel to the equipotential lines. Accordingly, the liquid crystal molecules 20a in each pixel are oriented to tilt from the peripheral portions of the pixel toward the center portion of the pixel.

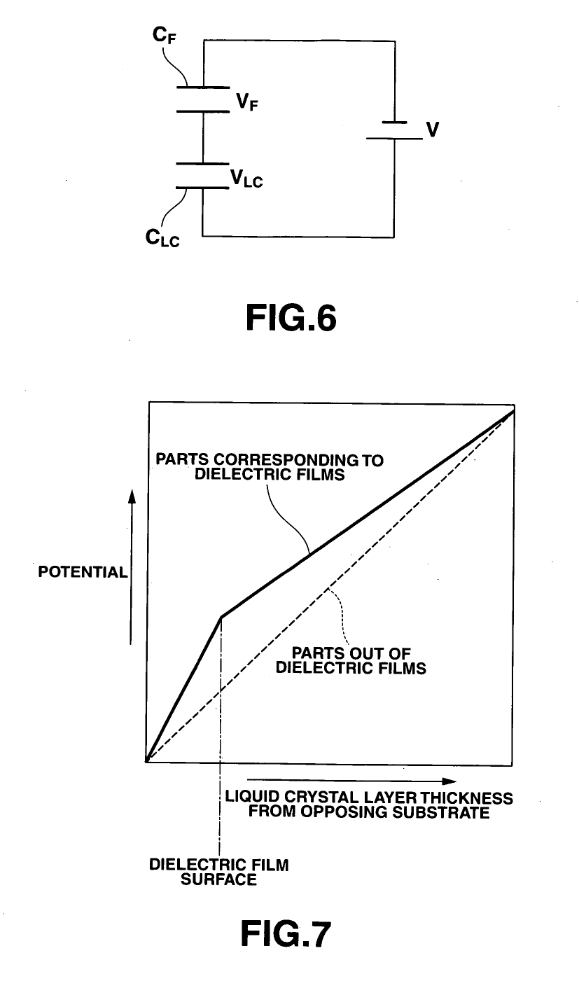

That is, in this liquid crystal display device, the dielectric films 18 are provided on the opposing electrode 15. Where capacitance created by the liquid crystal layer 20 (hereinafter called liquid crystal layer capacitance) is C_{LC} and capacitance created by the dielectric films 18 (hereinafter called dielectric capacitance) is C_{F}, the center portion corresponding to the dielectric film 18 in each pixel can be expressed as an equivalent to a serial connection circuit constituted by the dielectric capacitance C_{F} and the crystal layer capacitance C_{LC} as shown in FIG. 6.

Suppose now that V is a signal voltage applied between the electrodes 3 and 15 and V_{F} and V_{CL} are respectively voltages applied between two ends of the dielectric capacitance C_{F} and between two ends of the liquid crystal layer capacitance C_{LC} when the signal voltage V is applied. Then, the voltage V_{F} between two ends of the dielectric capacitance C_{F} and the voltage V_{LC} between two ends of the liquid crystal layer capacitance C_{LC} are expressed by the following expressions.
V_{F}=C_{LC}/(C_{F}+C_{LC})*V
V_{CL}=C_{F}/(C_{F}+C_{LC})*V

Suppose further that d is layer thickness of the liquid crystal layer 20 (layer thickness of part excluding the dielectric film 18), t is film thickness of the dielectric film 18, V is a write voltage applied between the pixel electrode 3 and the opposing electrode 15, and V_{F} and V_{CL} are respectively voltages between two ends of the dielectric capacitance C_{F} and between two ends of the liquid crystal layer capacitance C_{LC} when the write voltage V is applied. The voltage V_{F} between two ends of the dielectric capacitance C_{F} and the voltage V_{CL} between two ends of the liquid crystal layer capacitance C_{LC} are expressed by the following expressions.
V_{F}={ε_{LC}/(d−t)}/{(ε_{F}/t)+[ε_{LC}/(d−t)]}*V
V_{LC}={ε_{F}/t}/{(ε_{F}t)+[ε_{LC}/(d−t)]}*V

Thus, the voltage applied between the electrodes 3 and 15 to the liquid crystal layer in the region of the center portion of the pixel corresponding to the dielectric film 18 lowers.

Further, in the liquid crystal layer in each pixel, potentials from electrode surfaces are as shown in FIG. 7, with respect to the region where the dielectric film exists and the other region where the dielectric film does not exist. As shown in this figure, the potential gradient in the liquid crystal layer in the region where the dielectric film exists is smaller than that in the other region. Therefore, in each pixel, the potential distribution based on a voltage applied to the liquid crystal layer draw equipotential lines as shown in FIG. 5.

Therefore, in each pixel of this liquid crystal display element, the electric field generated between the electrodes 3 and 15 by applying the above-described signal voltage shows potential distribution in which the distances between equipotential planes are widened at the region of the center portion of the pixel corresponding to the dielectric film 18. That is, equipotential planes as shown in FIG. 5 which have peaks rising up toward the dielectric film 18 are created at the region of the center portion of the pixel corresponding to the dielectric film 18. Therefore, the liquid crystal molecules 20a are aligned with their axes of molecules oriented in the directions along the equipotential planes, and are oriented to tilt toward the center portion of the pixel corresponding to the dielectric film 18.

Further, when a voltage is applied between the electrodes 3 and 15, tilt of the liquid crystal molecules 20a at the center portion of the pixel (e.g., the region where the dielectric film exists) is smaller than that of the liquid crystal molecules 20a in the portion surrounding the center portion (e.g., the region where the dielectric film does not exist). Therefore, in each pixel, the liquid crystal molecules 20a begin tilting from the peripheral portions, and liquid crystal molecules 20a in the center portion of the pixel are oriented substantially at an angle perpendicular to or nearly perpendicular to the substrates 1 and 2, due to interactive force between liquid crystal molecules oriented so as to tilt from the periphery.

Thus according to this liquid crystal display device, liquid crystal molecules in each pixel are oriented to tilt regularly from the peripheral portion of the pixel toward the center portion of the pixel by applying a signal voltage. As a result, an excellent image can be displayed without unevenness.

Also, in this liquid crystal display device, the dielectric films 18 are formed of a dielectric material having a smaller dielectric constant than the dielectric constant ε_{LC} in the layer thickness direction of the liquid crystal layer 20 when a voltage is applied between the electrodes 3 and 15. Since there are many kinds of dielectric materials having such a dielectric constant, a dielectric material to form the dielectric films 18 can be easily chosen.

Further, in this embodiment the dielectric films 18 are formed of a dielectric material having a smaller dielectric constant than the dielectric constant ε_{⊥} in the direction vertical to the major axes of liquid crystal molecules. Therefore, liquid crystal molecules 20a in each pixel can be regularly oriented to tilt toward the center portion of the pixel from the peripheral portions of the pixel, and so, an excellent image can be displayed.

Furthermore, in this embodiment, the dielectric films 18 are formed of a dielectric material having a dielectric constant which is smaller than the dielectric constant ε_{⊥} in the direction vertical to the major axes of liquid crystal molecules and is greater than the dielectric constant ε_{∥} in a direction parallel to the major axes of liquid crystal molecules. Therefore, liquid crystal molecules 20a in each pixel can be more regularly oriented to tilt toward the center portion of the pixel from the peripheral portions of the pixel, and so, a more excellent image can be displayed.

In the embodiment described above, the dielectric films 18 are formed like rectangular dots. However, the dielectric films 18 are not limited to rectangular shapes but may be like circular dots, linear in one direction, or annular.

### Second Embodiment

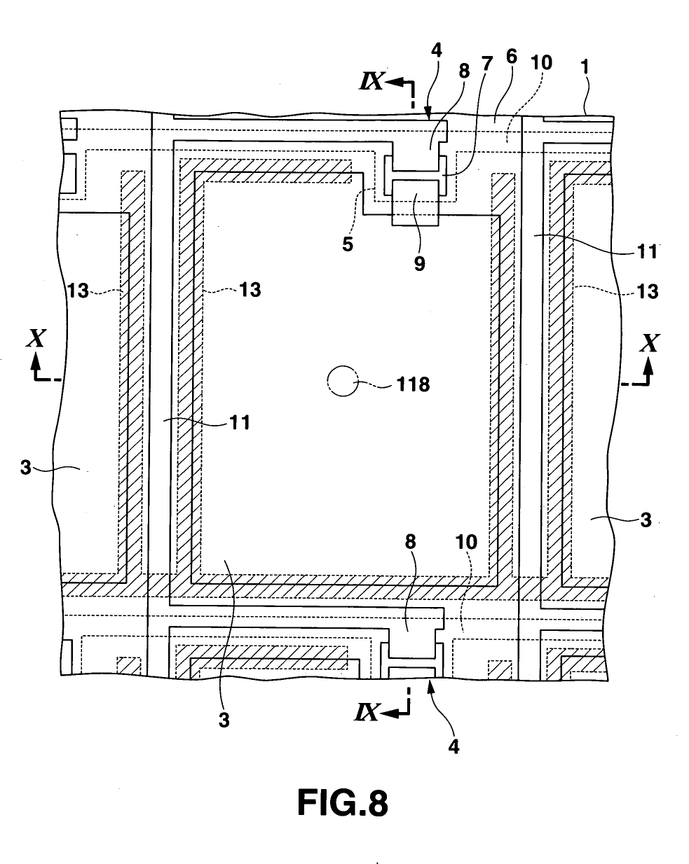

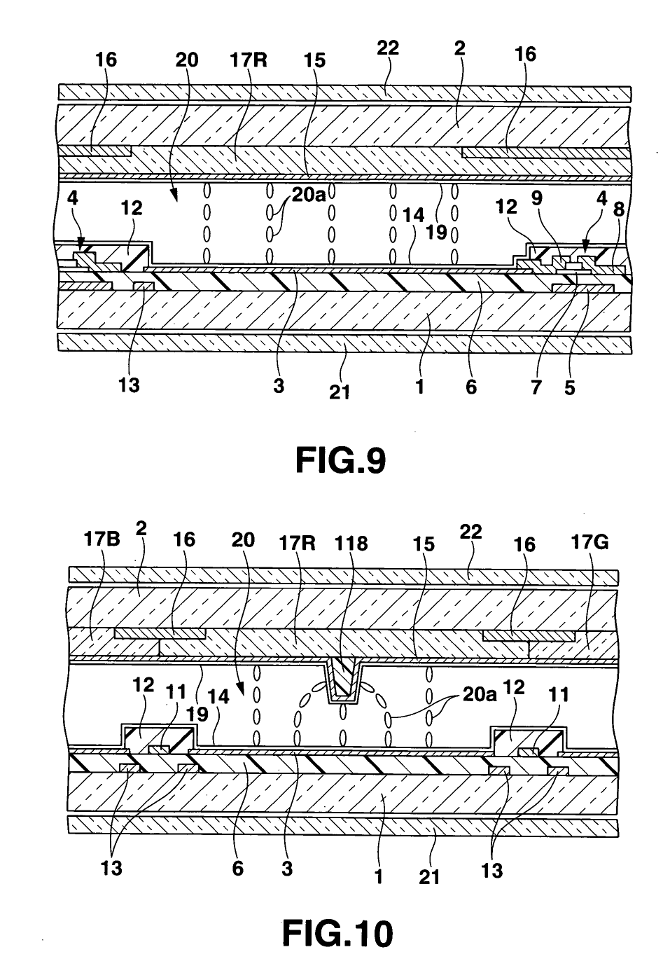

FIGS. 8 to 12 shows the second embodiment of the present invention. FIG. 8 is a plan view of one pixel part in one substrate of the liquid crystal display device. FIGS. 9 and 10 are cross-sectional views cut along lines IX-IX and X-X in FIG. 1

This liquid crystal display device is characterized in that in every pixel, a dielectric film is formed at the substantial center portion of the pixel, and a convex part is formed by providing an electrode on the dielectric film as well as a vertical-alignment film on this electrode. Except for this characterizing feature, the structure of the present embodiment is the same as that of the first embodiment described previously. Therefore, the identical members to those in the first embodiment will be denoted at the identical reference symbols, and descriptions of those members will be omitted herefrom.

As shown in FIGS. 8 to 10, the liquid crystal display device according to the second embodiment has: a TFT substrate 1 and an opposing substrate 2; pixel electrodes 3 and an opposing electrode 15 provided respectively on the mutually opposing inner surfaces of the TFT substrate 1 and opposing substrate 2; vertical-alignment films 14 and 15 which are provided covering the pixel electrodes 3 and opposing electrode 15 formed on these inner surfaces; and a liquid crystal layer 20 having negative dielectric anisotropy and sealed in a gap between the paired substrates 1 and 2.

On the inner surface of the opposing substrate 2, plural transparent convex parts 118 are provided, respectively corresponding to the center portions of the plural pixels. These convex parts 118 each are formed in a truncated-conical shape whose diameter decreased toward its own protruding end.

These plural convex parts 118 are formed of, for example, photosensitive resin or the like, on color filters 17R, 17G, and 17B formed on the inner surface of the opposing substrate 2. The opposing electrode 15 covers the convex parts 118 and are formed even on the surfaces of the convex parts 118.

Further, the vertical-alignment film 19 on the inner surface of the opposing substrate 2 is formed on the opposing electrode 15, covering upper parts of the convex parts 118.

Due to the vertical-alignment characteristic of the vertical-alignment films 14 and 19 respectively provided on the inner surfaces of the TFT substrate 1 and opposing substrate 2, the liquid crystal molecules 20a of the liquid crystal layer 20 are oriented in a vertical-alignment state in which the major axes of molecules are oriented in directions substantially vertical to the surfaces of the TFT substrate 1 and opposing substrate 2, in the other regions than the parts corresponding to the convex parts 118. In the parts corresponding to the convex parts 118, the liquid crystal molecules 20a near the convex parts 118 are oriented with their major axes of molecules oriented in directions substantially vertical to the surfaces of the convex parts 118 (e.g., end surfaces and circumferential surfaces of truncated cones) while the liquid crystal molecules 20a near the TFT substrate 1 are oriented with their major axes of molecules in directions substantially vertical to the surfaces of the TFT substrate 1 and opposing substrate 2.

In this liquid crystal display device, a signal voltage is applied between the pixel electrode 3 and the opposing electrode 15, for every one of plural pixels. The liquid crystal molecules 20a are thereby oriented to tilt from a vertical-alignment state, to display an image.

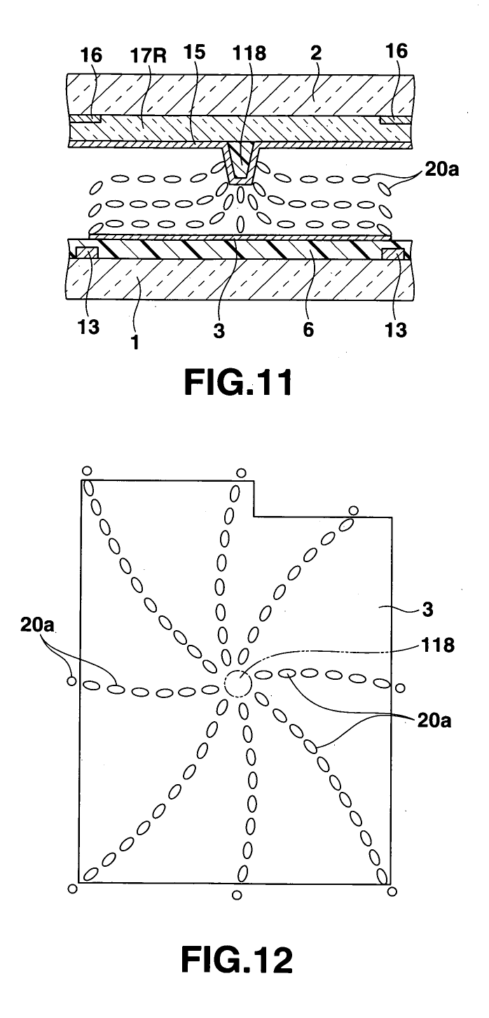

FIGS. 11 and 12 are respectively cross-sectional and plan views showing a tilted-alignment state of the liquid crystal molecules 20a in one pixel. In each pixel, as the signal voltage is applied, the liquid crystal molecules 20a tilt to be aligned spirally from the peripheral portion of the pixel toward the center portion of the pixel and are oriented to be substantially vertical to the surface of the convex part 118.

In the liquid crystal display device according to this embodiment, the convex parts 118 are provided on the inner surface of the opposing substrate 2, respectively corresponding to the center portions of plural pixels. The liquid crystal molecules 20a near the convex part 118 are oriented in a state in which the major axes of molecules are oriented in directions substantially vertical to the surface of the convex part 118. In this way, the liquid crystal molecules 20a in portions surrounding the convex part 118 are oriented so as to tilt obliquely toward the center portion of the pixel. By the intermolecular force acting between the liquid crystal molecules oriented obliquely and the liquid crystal molecules near the obliquely oriented molecules, the tilting direction of liquid crystal molecules 20a in each pixel, based on application of a signal voltage, can be defined such that the liquid crystal molecules 20a tilt from the peripheral portions of the pixel toward the center portion of the pixel. Accordingly, the liquid crystal molecules 20a in every pixel can be regularly oriented to tilt, so that an excellent image without unevenness can be displayed.

In addition, in this liquid crystal display device, the opposing electrode 15 of the opposing substrate 2 is formed covering the convex parts 118. Therefore, electric charges of the signal voltage are not charged in the convex parts 118. Accordingly, burn-in on a display can be prevented.

That is, in this liquid crystal display device, the opposing electrode 15 is formed covering the convex parts 118. Charging of electric charges into the convex parts 118 can be eliminated, so that burn-in on a display can be prevented.

### Third Embodiment

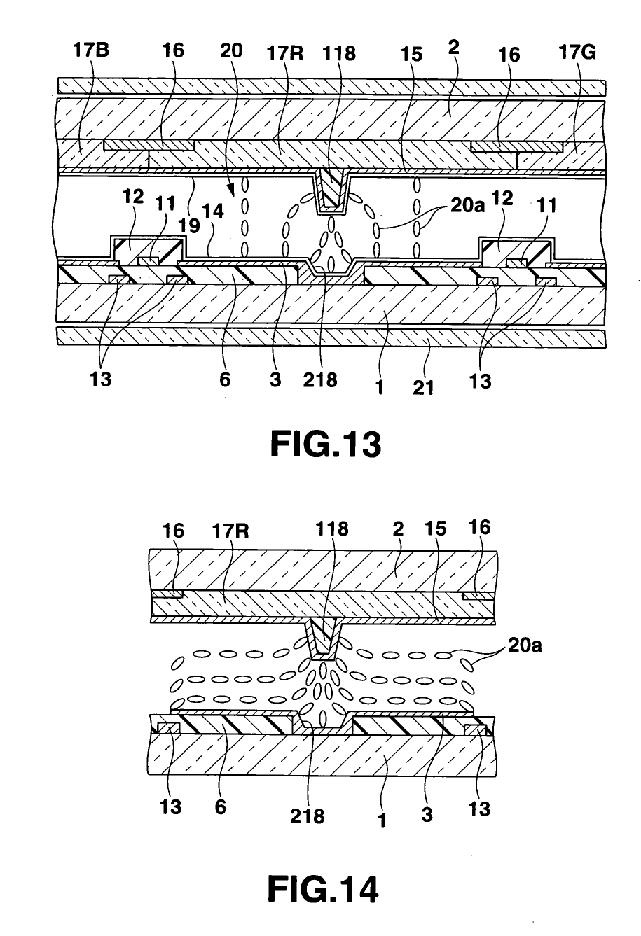

FIGS. 13 and 14 show the third embodiment of the present invention, and FIG. 13 is a cross-sectional view showing one pixel part of a liquid crystal display device.

Those members of the liquid crystal display device according to the present embodiment that correspond to the members of the liquid crystal display devices according to the first and second embodiments are denoted at the same reference symbols. Descriptions of those same members will be omitted herefrom.

In the liquid crystal display device according to the present embodiment, plural transparent convex parts 118 are provided on the inner surface of an opposing substrate 2, respectively corresponding to the center portions of plural pixels. An opposing electrode 15 on the inner surface of the opposing substrate 2 is formed covering the convex parts 118. On the inner surface of the TFT substrate 1, plural concave parts 218 are provided respectively corresponding to the plural convex parts 118 provided on the inner surface of the opposing substrate 2. Except for this feature, the structure of the liquid crystal display device is the same as those of the first and second embodiments.

In the present embodiment, the plural convex parts 118 of the opposing substrate 2 each are formed of a dielectric film in a truncated-conical shape, like in the second embodiment described previously. Each of the concave parts 218 on the TFT substrate 1 has a concentric-circular shape which is concentric with the truncated-conical convex part 118 and has a circumferential surface inclined in a direction in which the diameter increases from the bottom side of the concave part 218 toward the open face side.

The concave parts 218 are formed in the following manner. Circular cavities having a diameter greater than the convex parts 118 are cut in a gate insulating film 6 provided on the substrate surface of the TFT substrate 1, and plural pixel electrodes 3 each are formed on the gate insulating film 6 in a shape in which the part corresponding to the circular cavity is engaged in along the circumferential surface of the circular cavity and along the substrate surface exposed to the circular cavity. The vertical-alignment film 14 on the inner surface of the TFT substrate 1 is formed covering the upper side of the concave parts 218.

In this embodiment, circular cavities vertical to the gate insulating film 6 are formed, and parts of the pixel electrodes 3 which correspond to the circumferential surfaces of the circular cavities are formed such that the film thickness decreases toward the film surface side of the gate insulating film 6 from the substrate surface side. In this manner, the concave parts 218 whose circumferential surfaces are inclined are formed. Alternatively, the concave parts 218 may be formed by providing tapered holes in the gate insulating film 6 and by forming the pixel electrodes 3 on the circumferential surfaces of the tapered holes, to have substantially equal film thickness.

Further, due to the vertical-alignment characteristic of the vertical-alignment films 14 and 19 provided respectively on the inner surfaces of the paired substrates 1 and 2, liquid crystal molecules 20a in the liquid crystal layer 20 sealed between paired substrates 1 and 2 are oriented with their major axes of molecules oriented in directions substantially vertical to the substrates 1 and 2, in the other regions than the parts corresponding to the convex parts 118 and concave parts 218. In the parts corresponding to the convex parts 118 and concave parts 218, the liquid crystal molecules 20a near the convex parts 118 of the opposing substrate 2 are oriented with their axes of molecules oriented in directions substantially vertical to the surfaces of the convex parts 118 (e.g., end surfaces and circumferential surfaces of truncated cones) while the liquid crystal molecules 20a near the concave parts 218 of the TFT substrate 1 are oriented with their axes of molecules oriented in directions substantially vertical to the concave parts 218 (bottom surfaces and circumferential surfaces of concave surfaces).

FIG. 14 is a cross-sectional view showing a tilted-alignment state of liquid crystal molecules 20a in one pixel part of the liquid crystal display device according to this embodiment. In each pixel, as the signal voltage is applied between the pixel electrode 3 and the opposing electrode 15, the liquid crystal molecules 20a tilt to be aligned spirally from the peripheral portion to the center portion of the pixel, as shown in FIG. 14, and are oriented to be substantially vertical to the surface of the convex part 118 and the concave part 218.

According to the liquid crystal display device of the present embodiment, on the inner surface of the opposing substrate 2, convex parts 118 are provided, respectively corresponding to the center portions of the plural pixels, and on the inner surface of the TFT substrate 1, concave parts 218 are provided respectively corresponding to the plural convex parts 118. As a result, the liquid crystal molecules 20a near the convex parts 118 are oriented with their axes of molecules oriented in directions substantially vertical to the surfaces of the convex parts 118 while the liquid crystal molecules 20a near the concave parts 218 are oriented with their axes of molecules oriented in directions substantially vertical to the concave parts 218. In this way, the liquid crystal molecules in portions surrounding the convex part 18 are oriented so as to tilt obliquely toward the center portion of the pixel, and the liquid crystal molecules contacting the inner side surfaces of the concave parts 218 are oriented so as to tilt obliquely toward the center portion of the pixel. As a result, the tilting direction of liquid crystal molecules 20a in each pixel, depending on application of a signal voltage, can be defined so as to tilt from the peripheral portions of the pixel toward the center portion of the pixel, due to interactive force acting between the liquid crystal molecules oriented obliquely and the liquid crystal molecules near the obliquesly oriented molecules. Therefore, the liquid crystal molecules 20a can be regularly oriented to tilt with more steadiness, and so, a more excellent image can be displayed.

Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2004-343927 filed on Nov. 29, 2004 and Japanese Patent Application No. 2004-374606 filed on Dec. 24, 2004 and including specification, claims, drawings and summary. The disclosures of the above Japanese Patent Applications are incorporated herein by reference in their entireties.

What is claimed is:

1. A liquid crystal display device comprising:
a pair of substrates opposed to each other with a predetermined gap maintained therebetween;
electrodes provided respectively on mutually opposing inner surfaces of the pair of substrates, and defining plural pixels by mutually opposing regions, the plural pixels being arrayed in a matrix;
dielectric films provided respectively corresponding to substantial center portions of regions of one of the substrates, the regions corresponding to the plural pixels;
vertical-alignment films provided respectively on the inner surfaces of the paired substrates, covering the electrodes and the dielectric films; and
a liquid crystal layer having negative dielectric anisotropy and sealed in the gap between the pair of substrates.

2. The liquid crystal display device according to claim 1, wherein the dielectric film is formed at the substantial center of each pixel formed on one of the substrates, and has a dielectric constant different from another dielectric constant of the liquid crystal layer in a layer thickness direction of the liquid crystal layer when a voltage is applied between electrodes of the pair of substrates.

3. The liquid crystal display device according to claim 2, wherein the dielectric films are formed of a dielectric material having a smaller dielectric constant than the another dielectric constant of the liquid crystal layer in the layer thickness direction thereof when the voltage is applied between the electrodes.

4. The liquid crystal display device according to claim 2, wherein the dielectric films are formed of a dielectric material having a dielectric constant which is smaller than further another dielectric constant of liquid crystal in a direction vertical to major axes of molecules of the liquid crystal.

5. The liquid crystal display device according to claim 2, wherein the dielectric films are formed of a dielectric material having a dielectric constant which is smaller than further another dielectric constant of liquid crystal in a direction perpendicular to major axes of molecules of the liquid crystal and is greater than still further another dielectric constant of the liquid crystal in a direction parallel to the major axes of molecules of the liquid crystal.

6. The liquid crystal display device according to claim 2, further comprising auxiliary electrodes formed at least along peripheries of the pixels are provided on a surface of one of the substrates opposed to the other substrate, the surface being provided with the electrode.

7. The liquid crystal display device according to claim 6, wherein the auxiliary electrode is set to a lower potential than the electrode formed on the other one of the substrates.

8. The liquid crystal display device according to claim 6, wherein the auxiliary electrodes are provided, partially overlapping peripheral portions of the electrodes formed on the one of the substrates.

9. The liquid crystal display device according to claim 1, wherein the dielectric films form projecting parts at the substantial centers of the pixels respectively, the projecting parts include the electrodes formed on the dielectric films and a vertical-alignment film formed on the electrodes.

10. The liquid crystal display device according to claim 9, further comprising a plurality of recess parts provided on the inner surface of the other substrate opposed to the one of the substrates on which the projecting parts are formed, the recess parts corresponding to the plurality of aid projecting parts provided on the inner surface of the one of the substrates.

11. A liquid crystal display device comprising:
a first substrate on which at least one electrode is provided;
a second substrate which is opposed to the first substrate with a predetermined gap maintained from the first substrate, and on which at least one second electrode is provided, each of the at least one the second electrode defining a pixel by a region opposed to the first electrode, to array the plural pixels in a matrix;
auxiliary electrodes formed at least along peripheries of regions of the pixels, on a surface of the second substrate where the second electrode is provided;
dielectric films which are provided respectively corresponding to substantial center portions of pixels of the first substrate and have a dielectric constant different from another dielectric constant of a liquid crystal layer in a layer thickness direction when a voltage is applied between the first and second electrodes;
vertical-alignment films provided respectively on mutually opposing inner surfaces of the first and second substrates, covering the first and second electrodes and the dielectric films; and
the liquid crystal layer sealed between the first and second substrates and having negative dielectric anisotropy.

12. The liquid crystal display device according to claim 11, wherein the dielectric films are formed on the first electrode provided on the first substrate, and the vertical-alignment film is formed on the dielectric films.

13. The liquid crystal display device according to claim 11, wherein the dielectric films are formed of a dielectric material having a smaller dielectric constant than another dielectric constant of the liquid crystal layer in a layer thickness direction thereof when a voltage is applied between the electrodes.

14. The liquid crystal display device according to claim 11, wherein the dielectric films are formed of a dielectric material having a dielectric constant which is smaller than another dielectric constant of liquid crystal in a direction vertical to major axes of molecules of the liquid crystal.

15. The liquid crystal display device according to claim 11, wherein the dielectric films are formed of a dielectric material having a dielectric constant which is smaller than another dielectric constant of liquid crystal in a direction vertical to major axes of molecules of the liquid crystal and is greater than still another dielectric constant of the liquid crystal in a direction parallel to the major axes of molecules of the liquid crystal.

16. The liquid crystal display device according to claim 11, wherein the auxiliary electrodes are formed substantially throughout the whole peripheries of the second electrode.

17. The liquid crystal display device according to claim 11, wherein an active element connected to each of the at least one second electrode to supply the second electrode with a voltage is provided on the second substrate, and
the auxiliary electrodes each are constituted by a compensating-capacitor electrode which is provided partly overlapping a peripheral portion of the second electrode formed on the second substrate, to form a compensating capacitor between the second electrode and the auxiliary electrode.

18. The liquid crystal display device according to claim 17, wherein the compensation auxiliary electrode is set to a potential equal to that of the first electrode.

19. A liquid crystal display device comprising:
a first substrate on which at least one electrode is provided;
a second substrate which is opposed to the first substrate with a predetermined gap maintained from the first substrate, and on which at least one second electrode is provided, each of the at least one the second electrode forming a pixel by a region opposed to the first electrode, to array the plural pixels in a matrix;
auxiliary electrode formed at least along peripheries of regions of the pixels, on a surface of the second substrate where the second electrode is provided;
dielectric films which are formed between the first electrode and the first substrate, respectively corresponding to substantial center portions of regions of the first substrate, the regions corresponding to the plural pixels, thereby to form convex portions on a surface of the first electrode;
vertical-alignment films provided respectively on mutually opposing inner surfaces of the first and second substrates, covering the first and second electrodes; and
the liquid crystal layer sealed between the first and second substrates and having negative dielectric anisotropy.

20. The liquid crystal display device according to claim 19, wherein plural concave parts are provided at positions on the second substrate opposed to the first substrate on which the convex parts are formed, the positions respectively corresponding to the plural convex parts.
